(19) United States
(12) Patent Application Publication
(10) Pub. No.: US 2019/0151685 A1
(43) Pub. Date: May 23, 2019

(54) POWERED AIR PURIFYING RESPIRATOR WITH CYLINDRICAL CARTRIDGE

(71) Applicant: HONEYWELL INTERNATIONAL INC., Morris Plains, NJ (US)

(72) Inventors: Garaga Phani KUMAR, Morris Plains, NJ (US); Swapnil Gopal PATIL, Morris Plains, NJ (US); Praveen Kumar PALACHARLA, Morris Plains, NJ (US); Samit V. CHAUDHARI, Morris Plains, NJ (US)

(21) Appl. No.: 16/313,996

(22) PCT Filed: Jun. 29, 2016
(86) PCT No.: PCT/US2016/039954

§ 371 Date: Dec. 28, 2018

(51) Int. Cl. A62B 18/00; A62B 17/00

(52) U.S. Cl. CPC A62B 18/006; A62B 23/02; A62B 17/006

(57) ABSTRACT

Embodiments relate generally to a powered air purifying respirator (PA-PR) comprising a housing that is less than approximately 7 inches in width; a cylindrically shaped filter located within the housing; and a blower located within the housing, operable to force air through the cylindrically shaped filter. The cylindrically shaped filter may comprise a first filter layer and a second filter layer, wherein the first filter layer may comprise a particulate filter, and wherein the second filter layer may comprise a gas filter. In some embodiments, the second filter layer may comprise carbon particles.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Powered air purifying respirators (PAPRs) utilize a mechanism, such as a blower, impeller, fan or other mechanism, to draw ambient air through air purifying elements to remove contaminants from the air. PAPRs are designed to be human portable for use in atmospheres with solid and liquid contaminants, gases, and/or vapors to provide a useable and safe supply of breathable air where the concentrations of contaminants are not immediately dangerous to life or health and the atmosphere contains adequate oxygen to support life. PAPRs carry a self-contained power source, such as a battery, to energize a motor to drive the blower, impeller, or fan. The self-contained power source desirably is sized small enough so the PAPR is readily human portable and large enough that the PAPR can be used without recharging the power source for a portion of a work shift effective to promote efficient worker operation.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a PAPR worn with a headpiece (or hood) according to an embodiment of the disclosure;

FIGS. 2A-2B illustrate the dimensions of a PAPR according to an embodiment of the disclosure;

FIG. 3 illustrates an exploded view of a PAPR according to an embodiment of the disclosure;

FIG. 4 illustrates a cross-sectional view of a PAPR according to an embodiment of the disclosure;

FIG. 5 illustrates another cross-sectional view of a PAPR according to an embodiment of the disclosure;

FIGS. 6A-6B illustrate a filter for use with a PAPR according to an embodiment of the disclosure;

FIG. 7 illustrates a cross-sectional view of a PAPR according to an embodiment of the disclosure; and

FIG. 8 illustrates another cross-sectional view of a PAPR according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for providing a powered air purifying respirator (PAPR) with a cylindrical cartridge. PAPRs utilize a powered mechanism to draw ambient air through an air-purifying element(s) to remove contaminants from the ambient air. They are designed for use as respiratory protection against atmospheres with solid and liquid contaminants (e.g., dusts, fumes and/or mists), gases, and/or vapors, where the concentrations during entry and use are not immediately dangerous to life or health and the atmosphere contains adequate oxygen to support life.

Because a user must carry the PAPR on their body, the size and weight of the PAPR system may be configured to be minimized. One factor that contributes to the size and weight is the battery or power source in the PAPR. Increase air flow resistance through the filter cartridge of the PAPR may require a larger battery to power the PAPR. Additionally, the size of the filter cartridge may contribute to the size and/or weight of the PAPR. Therefore, it may be desired to reduce the air resistance through the PAPR without significantly increasing the size of the filter cartridge.

Some embodiments of the disclosure comprise a cylindrically shaped filter cartridge, wherein the surface area of air flow through the filter may be maximized while the size of the filter cartridge is minimized. Using a cylindrically shaped filter may also reduce the air resistance through the filter when compared to a rectangular filter.

For example, comparing a rectangular filter with a filter volume of approximately 310,000 mm³ and a cylindrical filter of approximately the same filter volume, the surface area of the filter element in the rectangular filter may be approximately 271,920 mm², while the surface area of the filter element in the cylindrical filter may be approximately 416,000 mm². In other words, a cylindrical filter may have significantly more filter surface area than a rectangular filter of a comparable size/volume. Increasing the filter surface area may decrease the air flow resistance through the filter. Accordingly, the load on the blower (and therefore the battery) may be reduced, thereby reducing the required battery size and overall product size and weight.

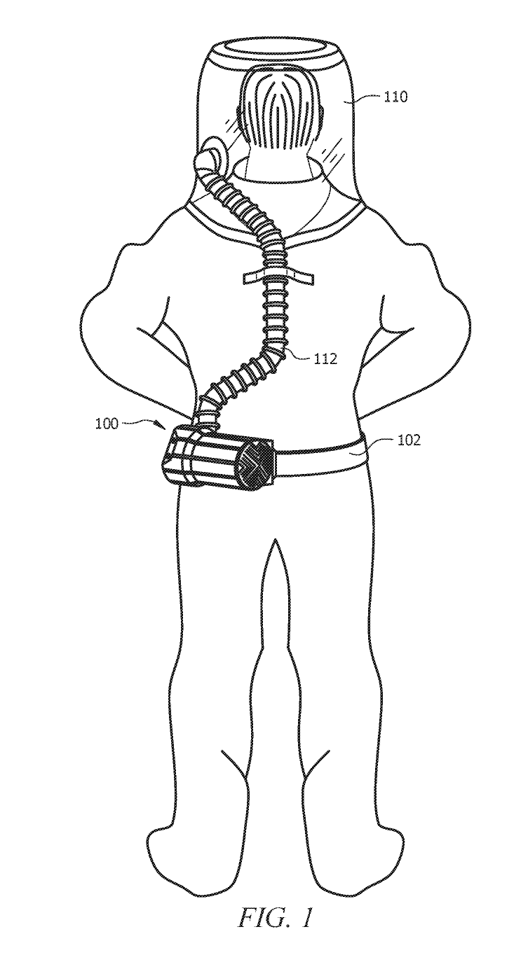

Referring now to FIG. 1, an embodiment of a PAPR 100 is shown. In some embodiments, the PAPR 100 may be worn by a user on a belt 102, or other harness or securing element. In some embodiments, the PAPR 100 may be used with a headpiece or facepiece 110, such as a hood and/or mask, wherein a hose may connect the PAM 100 to the facepiece 110. In some embodiments, the PAPR 100 may attach to the facepiece 110 via a hose 112.

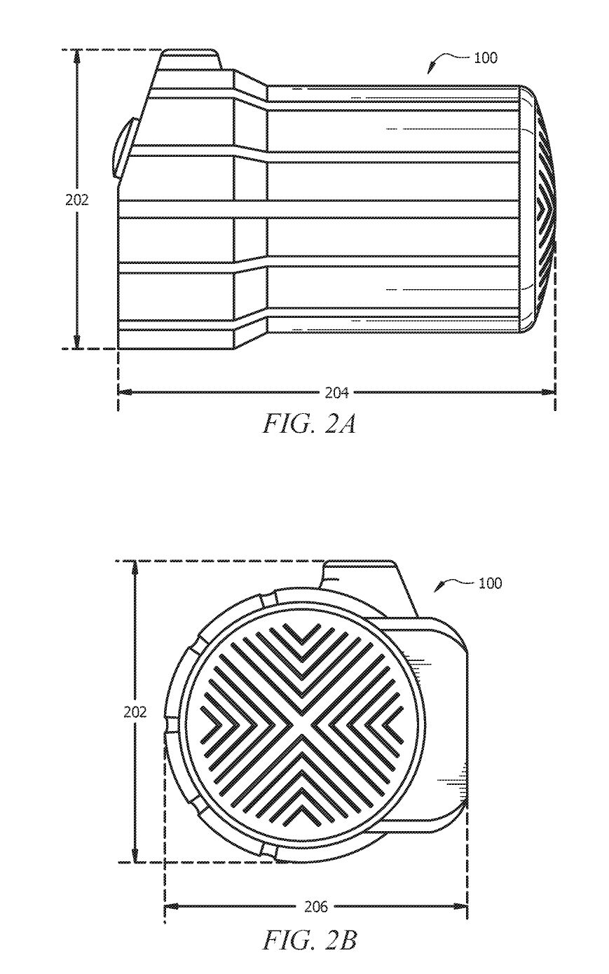

Referring now to FIGS. 2A-2B, exemplary dimensions of the PAPR 100 are shown. The PAPR 100 may comprise a height 202, length 204, and width 206. In some embodiments of the PAPR 100, the height 202 may be less than approximately 8 inches. In some embodiments of the PAPR 100, the height 202 may be less than approximately 6 inches. In some embodiments of the PAPR 100, the height 202 may be approximately 5 inches. In some embodiments of the PAPR 100, the length 204 may be less than approximately 10 inches. In some embodiments of the PAPR 100, the length 204 may be less than approximately 8 inches. In some embodiments of the PAPR 100, the length 204 may be approximately 6 inches. In some embodiments of the PAPR 100, the width 206 may be less than approximately 6 inches. In some embodiments of the PAPR 100, the width 206 may be less than approximately 4 inches. In some embodiments of the PAPR 100, the width 206 may be approximately 3 inches.

The dimensions of the PAPR 100 may be minimized while maintaining the filtering capabilities of the PAPR 100. The cylindrical shape of the PAPR 100 may allow for an increased filtering surface area.

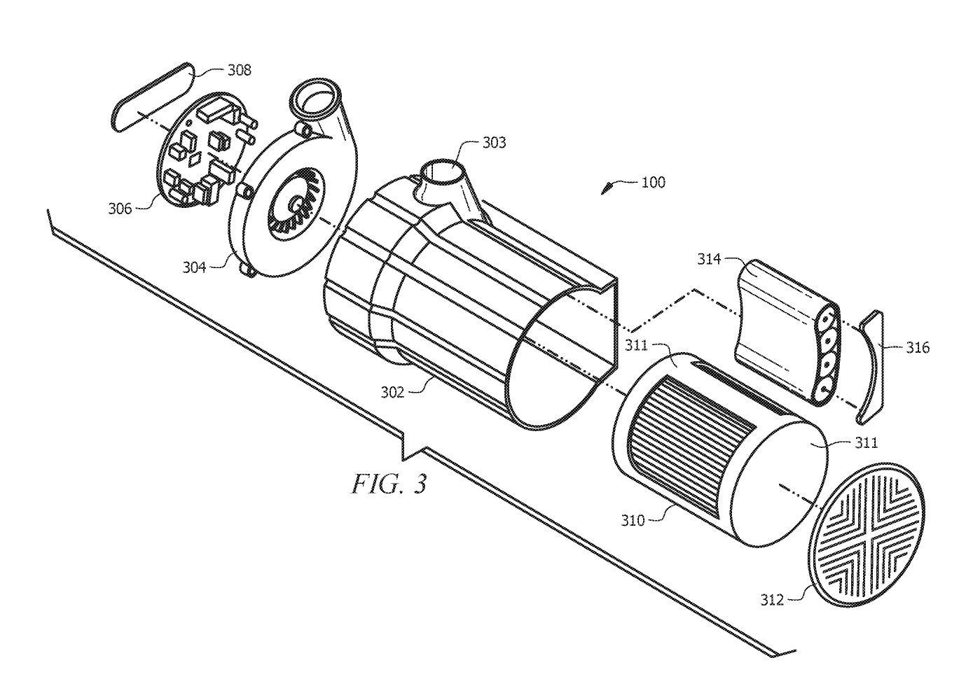

Referring to FIG. 3, an exploded view of the PAPR 100 is shown. The PAPR 100 may comprise a housing 302, wherein the housing 302 may comprise an outlet 303. In some embodiments, the outlet 303 may be configured to attach to a hose (similar to the hose 112 of FIG. 1). In some embodiments, the PAPR 100 may comprise a blower 304 (which may also be known as a fan and/or an impeller). The blower 304 may fit into the housing 302, wherein the blower 304 forces air through the PAPR 100 and out the outlet 303 of the housing 302. In some embodiments, the PAPR 100 may comprise a printed circuit board (PCB) 306, wherein the PCB 306 may be operable to control and/or receive information from other elements within the PAPR 100. In some embodiments, the PAPR 100 may comprise a user interface 308, wherein the user may input commands to the PAPR 100 and/or receive information from the PAPR 100. The user interface 308 may include a screen, one or more buttons, and/or one or more indicators. In some embodiments, the PAPR 100 may comprise a power source, such as one or more batteries 314, operable to power the elements of the PAPR 100. The batteries 314 may be configured to fit inside the housing 302. In some embodiments, the housing 302 may comprise a battery cover 316 operable to fit over the batteries 314, wherein the battery cover 316 may be removable. The battery cover 316 may be removed to replace the batteries 314 as needed.

In some embodiments, the PAPR 100 may comprise a filter 310, wherein the filter 310 may comprise a cylindrical shape. The filter 310 may be operable to fit inside the housing 302. The PAPR 100 may also comprise a mesh cover 312 fitted on one end of the housing 302. The mesh cover 312 may allow air to be pulled into the housing 302 by the blower 304, wherein the air may flow through the filter 310. In some embodiments, the filter 310 may comprise a frame 311 holding the filter material within the filter 310. In some embodiments, the mesh cover 312 may be removable from the housing 302, wherein the filter 310 may be removed and/or replaced.

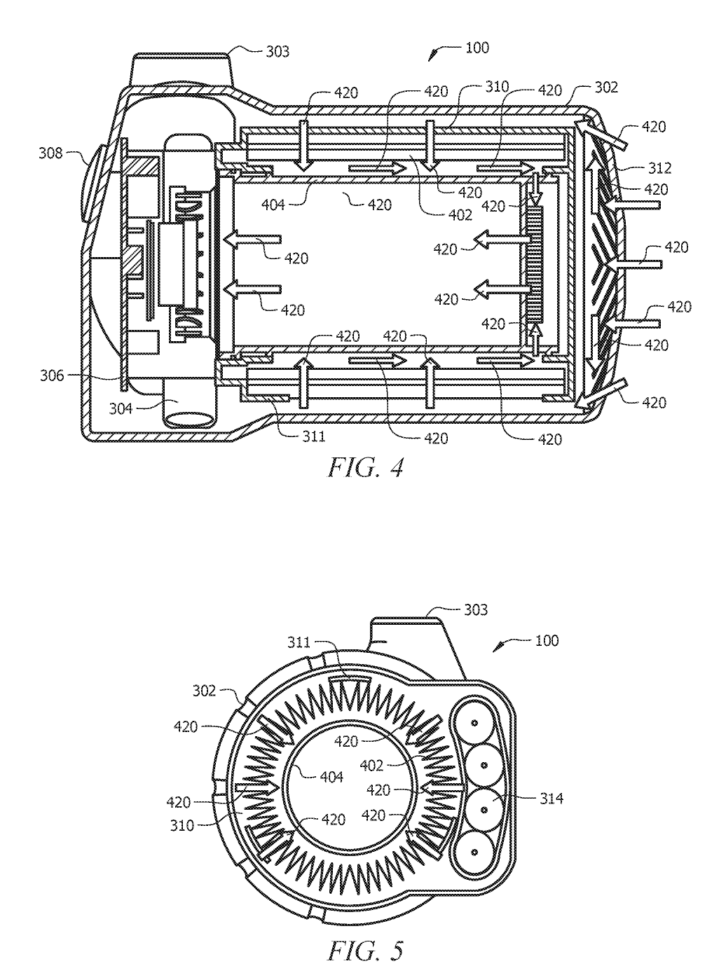

FIG. 4 illustrates a cross-sectional view of the PAPR 100, showing the elements of the PAPR 100 located within the housing 302. As shown in FIG. 3, the filter 310 may comprise a frame 311 operable to contain/hold the filter material within the filter 310. In some embodiments, the filter 310 may comprise multiple layers of filter material, wherein the filter material may comprise multiple types of materials. In the embodiment shown in FIG. 4, the filter 310 may comprise a first filter layer 402 and a second filter layer 404. The first filter layer 402 may be exposed via openings in the frame 311.

The air flow 420 through the filter is illustrated by arrows through the housing 302. The air flow 420 may be pulled into the housing 302 through the mesh cover 312. The air flow 420 may be directed around the filter 310 and into the center of the filter 310 through the first filter layer 402 and then through the second filter layer 404. In some embodiments, the air flow 420 may pass through the first filter layer 402 around the frame 311 of the filter 310. Then, the second filter layer 404 may comprise an air tight housing, operable to direct the air flow 420 toward the end of the second filter layer 404. The air flow 420 may then enter the center of the second filter layer 404 and be pulled toward the blower 304. The air flow 420 may be pulled into the blower 304, and then pushed out of the housing 302 through the outlet 303 (where a hose may attach).

FIG. 5 illustrates another cross-sectional view of the PAPR 100 (perpendicular to the cross-section of FIG. 4), The airflow 420 through the filter 310 is shown, wherein the airflow 420 may be directed toward the center of the filter 310. As described above, the frame 311 of the filter 310 may extend over only part of the exterior of the filter 310, thereby exposing the first filter layer 402.

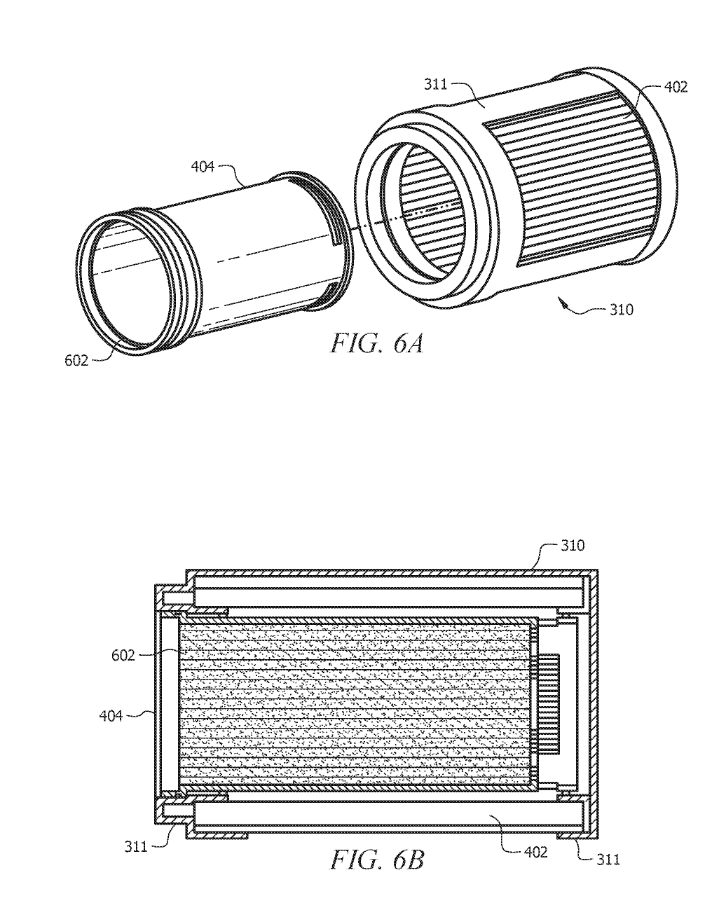

FIG. 6A illustrates an exploded view of the filter 310. In the embodiment shown in FIG. 6A, the second filter layer 404 may comprise a filter material 602. In an embodiment, the first filter layer 402 may comprise a particulate filter. In some embodiments, the first filter layer 402 may comprise a high-efficiency particulate arresting (HEPA) filter. In an embodiment, the second filter layer 404 may comprise a gas filter, wherein the filter material 602 may comprise carbon particles located within the second filter layer 404. FIG. 6B shows a cross-sectional view of the assembled filter 310 containing the filter material 602.

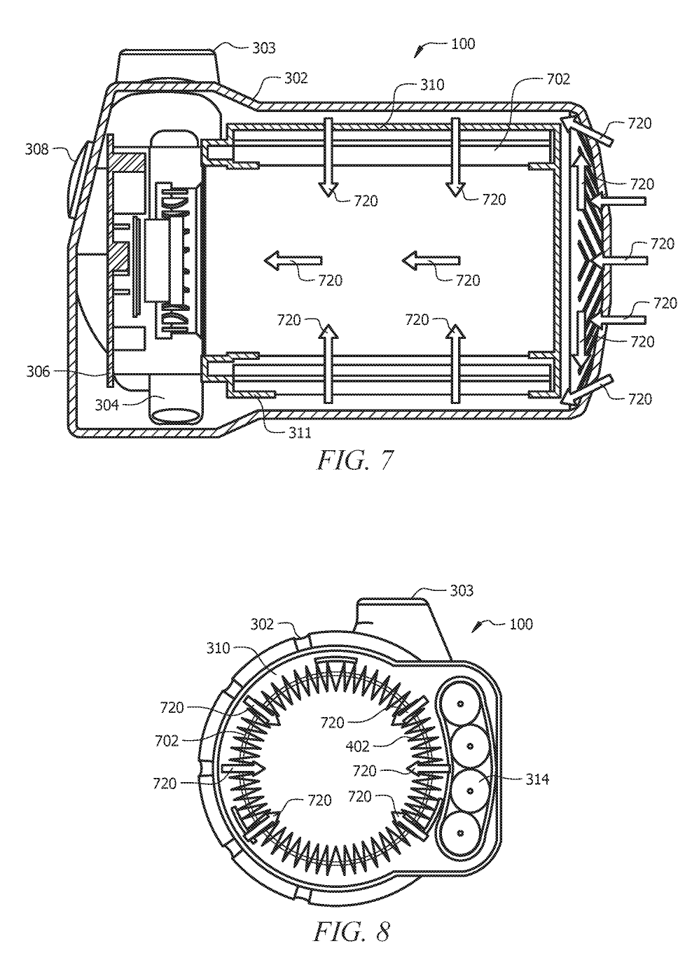

FIG. 7 illustrates a PAPR 100 where the filter 310 may comprise a first filter layer 702. The air flow 720 may be illustrated via arrows through the housing 302. The air flow may enter housing 302 and pass through the first filter layer 702 of the filter 310 into the center of the filter 310.

FIG. 8 illustrates a cross-sectional view of the PAPR 100 shown in FIG, 7, wherein the PAPR 100 may comprise a first filter layer 702, and the air flow 720 may pass through the first filter layer 702 into the center of the filter 310. In some embodiments, the first filter layer 702 may comprise a particulate filter.

Some embodiments of the disclosure may comprise a powered air purifying respirator (PAPR) comprising a housing that is less than approximately 7 inches in width; a cylindrically shaped filter located within the housing; and a blower located within the housing, operable to force air through the cylindrically shaped filter.

In an embodiment of the PAPR, the PAPR may further comprise a printed circuit board (PCB) operable to control one or more elements of the PAPR; and a power source. In an embodiment of the PAPR, the PAPR may further comprise a user interface operable to communicate with the PCB. In an embodiment of the PAPR, the cylindrically shaped filter comprises a first filter layer and a second filter layer. In an embodiment of the PAPR, the first filter layer comprises a particulate filter. In an embodiment of the PAPR, the second filter layer comprises a gas filter. In an embodiment of the PAPR, the second filter layer comprises carbon particles. In an embodiment of the PAPR, the air flow through the housing is directed through the first filter layer and then through the second filter layer. In an embodiment of the PAPR, the first filter layer and the second filter layer are centered axially within the cylinder shape. In an embodiment of the PAPR, the PAPR is worn on a user's body, and the housing extends from the user's body by less than approximately 4 inches. In an embodiment of the PAPR, the housing is approximately 5 inches in height. In an embodiment of the PAPR, the housing is approximately 6 inches in length. In an embodiment of the PAPR, the housing is approximately 3 inches in width. In an embodiment of the PAPR, the PAPR is worn on a belt by the user. In an embodiment of the PAPR, the PAPR further comprises an outlet operable to attach to a hose. In an embodiment of the PAPR, the blower is operable to draw air through the filter and then force air out of the outlet.

Some embodiments of the disclosure may comprise a filter for use with a powered air purifying respirator (PAPR), wherein the filter comprises a cylindrical shape, wherein the length of the filter is greater than the diameter of the filter; a first filter layer operable to filter particulate matter; and a second filter layer operable to filter gases, wherein the first filter layer and the second filter layer are centered axially with one another.

Some embodiments of the disclosure may comprise a method for manufacturing a powered air purifying respirator (PAPR) comprising providing a cylindrically shaped filter, wherein at least a portion of the filter material extends around the surface of the cylinder; assembling the filter within a housing; and assembling a blower within the housing, wherein the blower is configured to force air through the cylindrically shaped filter.

In an embodiment of the method, the method may further comprise assembling a particulate filter layer and a gas filter layer within the cylindrically shaped filter. In an embodiment of the method, the method may further comprise assembling a printed circuit board (PCB) within the housing, wherein the PCB is operable to control one or more elements of the PAPR.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art, to any invention(s) in this disclosure. Neither is the “Summary” to be considered as a limiting characterization. of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing froth this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1-15. (canceled)

16. A powered air purifying respirator (PAPR) comprising:
a housing that is less than approximately 7 inches in width;
a cylindrically shaped filter located within the housing and comprising:
a cylindrical shape, wherein the length of the filter is greater than the diameter of the filter;
a first filter layer; and
a second filter layer, wherein the first filter layer and the second filter layer are centered axially with one another; and
a blower located within the housing, operable to force air through the cylindrically shaped filter.

17. The PAPR of claim 16, further comprising: a printed circuit board (PCB) operable to control one or more elements of the PAPR; and a power source.

18. The PAPR of claim 16, further comprising a user interface operable to communicate with the PCB.

19. The PAPR of claim 16, wherein the first filter layer comprises a particulate filter.

20. The PAPR of claim 16, wherein the second filter layer comprises a gas filter.

21. The PAPR of claim 20, wherein the second filter layer comprises carbon particles.

22. The PAPR of claim 16, wherein the air flow through the housing is directed through the first filter layer and then through the second filter layer.

23. The PAPR of claim 16, wherein the first filter layer and the second filter layer are centered axially within the cylinder shape.

24. The PAPR of claim 16, wherein the PAPR is worn on a user's body, and wherein the housing extends from the user's body by less than approximately 4 inches.

25. The PAPR of claim 16, wherein the housing is approximately 5 inches in height.

26. The PAPR of claim 16, wherein the housing is approximately 6 inches in length.

27. The PAPR of claim 16, wherein the housing is approximately 3 inches in width.

28. The PAPR of claim 16, wherein the PAPR is worn on a belt by the user.

29. The PAPR of claim 16, further comprising an outlet operable to attach to a hose.

30. The PAPR of claim 26, wherein the blower is operable to draw air through the filter and then force air out of the outlet.

31. A filter for use with a powered air purifying respirator (PAPR), wherein the filter comprises:
a cylindrical shape, wherein the length of the filter is greater than the diameter of the filter;
a first filter layer operable to filter particulate matter; and
a second filter layer operable to filter gases, wherein the first filter layer and the second filter layer are centered axially with one another.

32. The filter of claim 31, wherein air flow through the filter is directed through the first filter layer and then through the second filter layer.

33. A method for manufacturing a powered air purifying respirator (PAPR) comprising:
providing a cylindrically shaped filter, wherein at least a portion of the filter material extends around the surface of the cylinder, and wherein the length of the filter is greater than the diameter of the filter;
assembling a particulate filter layer and a gas filter layer within the cylindrically shaped filter;
assembling the filter within a housing; and
assembling a blower within the housing, wherein the blower is configured to force air through the cylindrically shaped filter.

34. The method of claim 33, wherein the first filter layer and the second filter layer are assembled centered axially with one another.

35. The method of claim 33, further comprising assembling a printed circuit board (PCB) within the housing, wherein the PCB is operable to control one or more elements of the PAPR.
